(19) United States
(12) Patent Application Publication
(10) Pub. No.: US 2009/0230729 A1
(43) Pub. Date: Sep. 17, 2009

(54) FLOOR PANEL FOR A VEHICLE

(76) Inventor: Kevin Lusk, Gimli (CA)

Correspondence Address: ADE & COMPANY INC., 2157 Henderson Highway, WINNIPEG, MB, R2G1P9, CA

(21) Appl. No.: 12/047,477

(22) Filed: Mar. 13, 2008

(51) Int. Cl. B62D 25/20

(52) U.S. Cl. 296/193.07

(57) ABSTRACT

A structural shear panel for forming a floor panel for support by a vehicle frame is formed by a composite of top and bottom sheets and a core with a vacuum infused resin. The core is formed of top and bottom layers each formed from a honeycomb panel defining an array of hexagonal tubular cells with walls which extend in the thickness direction filled with a foam material. A third layer is located between the first and second layers and is formed of a material such as foam, rubber or cork which is free from tubular cells in the thickness direction and free from rigid structural members in the thickness direction to reduce communication of sound through the panel.

This invention relates to a floor panel to be used for example in a vehicle.

### BACKGROUND OF THE INVENTION

There has been an intention in the industry of mass transit vehicles to provide a vehicle body which is formed primarily of a composite material. Such composite materials generally comprise fibreglass reinforced resin sheets and often these are formed with a foam or other core layer between the sheets. The primary intention is that the structure be formed substantially wholly from such composite materials. The intention is that such materials will reduce weight and provide a superior corrosion resistance. One technique is to provide molds in which the body is shaped and formed from separate pieces which can then be connected together. However one highly desirable feature is that the structure can provide multiple different vehicle lengths to satisfy customer demands.

A number of attempts have been made for example, by Grumman ATTB, NABI who provided 40 and 45 feet length “Compobus”, a proposal by ABI, a proposal by TPI under the trade name “Airporter”, a proposal by Den Oudsten Bussen/Fokker Stork. However these proposals have been put forward in a manner that does not fully address one or more of the critical market entry or performance criteria resulting in a vehicle that has limited appeal or cannot meet the rigorous performance standards dictated by the transit agencies. In Europe, where road maintenance is superior relative to North America and durability is less of a concern, there has been little interest in lightweight composite vehicles. Den Oudsten Bussen created the RET X-98 which was to enter revenue service in Rotterdam, but aside from stirring momentary interest at a few shows, the modular vehicle could not save the company from bankruptcy. The Fokker-Stork body technology was licensed to APT Systems in Helmond NL which was incorporated into the Phileas, which has achieved little success. The license for the Fokker Stork body technology is held in North America by New Flyer but this again has achieved no commercial success.

One of the defining criteria is vehicle length. The market requires vehicles under 29 feet in length, 30 to 35 feet and 40 feet and 45 feet commuter buses together with 60 feet articulated vehicles. All previous attempts can be divided into two categories: one set of molds for each body length or various body lengths created by ganging modules. The multiple mold strategy of course provides a huge tooling expense. The multiple module technique has inherent weaknesses.

Up till now, therefore, no commercial vehicle of this type has been successfully exploited.

It will be appreciated that vehicles of this type can be used either as a light rail vehicle or as a road vehicle and many common features can be used in both structures. There are of course significant differences which will be well known to one skilled in the art but the principle set forth in the present application can in most cases be used in both fields.

A number of prior patents have been published showing features of the above mentioned commercial attempts and showing various other arrangements by other parties interested in this field.

The following patents have been noted as having some relevance in the present field

U.S. Pat. No. 5,042,395 (Wackerle) issued Aug. 27, 1991. Wackerle discloses a rail vehicle formed from molded upper section defining the side walls and roof connected to a floor section. The connection is provided by a corner piece which is bonded into an edge piece at each edge of each molded composite panel. The composite panels are formed from exterior sheets with a honey comb core between.

U.S. Pat. No. 5,140,913 (Takeichi) issued Aug. 25, 1992. Takeichi discloses a rail vehicle which is similarly constructed to the above except that it is formed in sections which are connected edge to edge along the length of the vehicle. The floor sections are formed from side beams and horizontal rails.

U.S. Pat. No. 5,433,151 (Ohara) issued Jul. 18, 1995 discloses a similar arrangement.

U.S. Pat. No. 5,904,972 (Tunis) issued May 18, 1999 discloses a technique for forming large composite core structures by vacuum assisted resin transfer molding. This is not particularly directed to vehicles but provides a technique which can form the large molded sections.

U.S. Pat. No. 5,918,548 (Elsner) issued Jul. 6, 1999 discloses a rail vehicle formed by connected beams.

U.S. Pat. No. 6,237,989 (Ammerlaan) issued May 29, 2001 discloses the arrangement of the Fokker Stork device described above which is defined as a molded structure formed by connected side panels, roof and floor sections where the drive components for the vehicle are bolted under the floor sections

U.S. Pat. No. 6,685,254 (Emmons) issued Feb. 3, 2004 discloses a vehicle which is primarily formed from a roof section and a floor section together with vertical beams where the roof and floor sections are formed as a sandwich panel defined by the fibre reinforced sheets and an interconnecting core.

PCT Publication No. WO/2004/000633 and 000634 assigned to NABI published 31 Dec. 2003 discloses a molded structure in which the body and floor are separately molded from fibre reinforced plastics material and in particular the floor panel is formed of a tray shaped platform where the whole of the lower part of the vehicle is molded in one piece including the floor, part of the side wall and all of the structural connections for attachment to the components of the vehicle.

In PCT Publication 2007/056,840 published 24 May 2007 by the present Applicants is provided a further arrangement to construct a vehicle of this type primarily from composite materials.

In US Published Application 2008/0044630 filed Aug. 30, 2007 and published Feb. 21, 2008 and assigned to the present Applicants which corresponds to Canadian Application 2,599,560 published Mar. 1, 2008 is a structural floor for use in a transit type vehicle. The disclosures of the above two applications of the Applicant are incorporated herein by reference.

Thus, as an alternative to manufacturing the whole or a major part of the vehicle from composite material it is also possible to form only the floor panels from composite materials. These floor panels can be part of a conventional structure where the panels are used in replacement for conventional plywood sheets and laid over a frame or chassis of cross members or the floor panel may form a shear plate which contributes significantly to the structure.

The composite panels are formed from an upper sheet, a bottom sheet and a core material between the sheets, where each of the sheets is formed of a fiber reinforced material so as to provide strength against tension in both longitudinal and transverse directions and the core material holds the first and second sheets spaced by a distance to provide a resistance of the panel to bending. Typically the core material is formed of a conventional honeycomb panel defining an array of hexagonal tubular cells extending between the first and second sheets. The honeycomb panel is typically formed from phenolic resin infused Kraft paper but other suitable materials can be used which are selected to bond to the foam and to provide a suitable compression strength. The honeycomb upstanding walls defining the tubular cells are filled with foam filling which is commonly polyurethane.

Such structural shear plates deployed as floors in commercial vehicles have proven beneficial manufacturers of such vehicle, who commonly have replaced the plywood floors in urban transit vehicles with the composite floor panels. These proved benefits which include:

Light weight;

Elimination of corrosion and floor rot;

Reduced labour;

Reduced assembly time;

Improved chassis stiffness and overall rigidity of the vehicle structure.

### SUMMARY OF THE INVENTION

It is one object of the invention to provide an improved floor panel for use in a transit vehicle.

According to one aspect of the invention there is provided a floor panel for a vehicle, the panel comprising:

a first sheet, a second sheet and a core material between the sheets where the core material fills a space between the sheets in a thickness direction;

each of the first and second sheets being formed of a fiber reinforced material so as to provide strength against tension in both a longitudinal direction and a transverse direction;

the core material having a thickness in the thickness direction so as to hold the first and second sheets spaced by a distance to provide a resistance of the panel to bending;

and a resin permeated through the sheets and into the core material;

the core material comprising a plurality of parallel layers parallel to the first and second sheets;

the parallel layers including a first layer and a second layer;

where the first and second layers are each formed from a honeycomb panel defining an array of hexagonal tubular cells with walls which extend in the thickness direction where at least some of the cells are at least partly filled with a foam material;

the parallel layers including a third layer located between the first and second layers;

the third layer being formed of a material which is free from tubular cells in the thickness direction and free from rigid structural members in the thickness direction.

Preferably the floor panel is arranged and constructed for resting upon and being supported by a structural frame of the vehicle so that the bottom surface of the panel rests on frame cross-members. However the structure may also be used in a floor of the type which is effectively a self supporting structural member of the vehicle.

Preferably there are only three layers but the panel may include more than three layers.

Preferably the first and second layers are arranged symmetrically and of equal thickness and third layer is a dividing layer located at a center of the panel. However the first and second layers may be of different thicknesses so that the third layer is not at the center.

The third layer can be of any homogeneous material which has some resilience in the thickness direction such as a foam material, rubber or cork. In some cases it may be is of substantially equal thickness to the first and second layers or it may be thinner than the first and second layers.

Generally it is important that the third layer is smaller than the first and second layers in the transverse and longitudinal directions so that the third layer is spaced from the edges of the panel so that there are spacer pieces at locations on the panel outside the third layer with the spacer pieces having a thickness substantially equal to the third layer.

Depending on the thickness of the third layer, the spacer pieces can formed from the same honeycomb material as the other layers or it may be formed from a fibrous mat.

In a particularly preferred arrangement, the third layer is formed from a layer of a high density closed cell foam material with faces thereof parallel to the sheets being covered by a foil.

Preferably there is provided a fibrous binding layer such as a polyester veil between the first layer and the third layer and between the second layer and the third layer with the fibrous binding layer being permeated with the resin.

The invention also includes a vehicle comprising:

a frame including a plurality of frame members for supporting a floor;

a floor panel placed over the frame so as to be supported by the frame members;

a floor panel being substantially as defined above.

Thus it has been found that the conventional composite sandwich floor has a tendency to transmit structure borne noise into the passenger cabin with less impedance than the previous plywood flooring. This can be a significant problem as there are now increasing demands for lower sound levels in transit vehicles.

It has been found by analysis that the main culprit is the direct, rigid link between the face skins, which is a function of the upstanding walls of the tubular cells of the honeycomb that encapsulates the polyurethane foam filling, and the resin tunnels that communicate between the face sheets. The resin tunnels facilitate transfer of resin through the core to the top and bottom layers of glass reinforcement. During the infusion process, resin is drawn through the dry reinforcement, into the tunnels, and through to the opposing face sheet, where it saturates the mat as well as the walls of the honeycomb. There is of course resin trapped in the vertical tunnels, which cures and becomes a rigid column. Together with the walls of the honeycomb, these columns transmit high frequency sound energy from the vehicle chassis to which the panel is bonded, to the interior face sheet. The face sheet is energized and the sound energy amplified.

Once the sound has reached the interior, it is virtually impossible to dampen, given the fact that the interior is comprised of hard surfaces which reflect the sound and further contribute to high noise levels, specifically in the frequencies which interfere with human speech—400, 800, 1200, and 2000 Hz. This level of irritation is unacceptable to the average bus rider and lower sound levels are becoming the hallmark of product acceptance.

The key to overcoming this negative effect is to decouple the face sheets. The honeycomb is an essential component of the superior mechanical attributes of the typical panel of this type, particularly its resistance to the development of shear lines at the neutral axis between the face sheets, which is common to pure foam cores.

It is known in the industry that plywood floors can be laminated with a visco-elastic veneer located at the neutral axis of the laminate. This is known as DB plywood and has been shown to effectively reduce the transmission of sound energy. Unfortunately, DB plywood is also substantially weaker than standard plywood, and subject to early failure due to delamination of the veneers under cyclical loading. The bond between the visco-elastic (usually vinyl) layer and the less flexible wood veneers results in delamination and the formation of a pocket in the plywood. Constant flexing of the veneers over the pocket results in pulverization of the veneers and eventually, the plywood “holes” through.

It is of course important in the present invention that the construction does not compromise the structural integrity of the sandwich, does not add to the light weight of the sandwich, and at the same time impedes the direct transmission of sound to the interior or tread sheet.

In a first embodiment a face sheet reinforcement is laid down as and a layer of foam-filled honeycomb core is laid over the reinforcement. The layer is equal to one third of the total core thickness to be encapsulated between the face sheets. A layer of non-woven polyester veil is laid over the first core sheet. The veil acts as an interface between the cores and becomes saturated with resin in the infusion process, binding the internal cores together. The acoustical barrier is laid over the veil. The layer is equal to one third of the total core thickness to be encapsulated between the face sheets. The acoustical barrier is comprised of high-density, closed cell foam encapsulated between two thin face sheets of aluminum foil. The acoustical barrier should not extend to the limits of the part to be molded; rather, the barrier covers roughly 60% of the total surface area and may be located in spots on the floor where there is likely to be more sound energy transmitted from the chassis. Standard honeycomb core is placed around the edges of the barrier core to fill out the core to the edges of the part. Another layer of veil is placed over the entire core surface, followed by a final layer of foam-filled honeycomb core, which extends to the extremities of the part. This layer is equal to one third of the total core thickness to be encapsulated between the face sheets. It is in turn overlaid with face sheet reinforcement. The sandwich is then resin infused. The resulting sandwich is acoustically “dead”, transmitting very little acoustic energy. The foil is a component of the molding process in that it protects the acoustic foam core from the momentarily corrosive effects of the styrene monomer contained in the laminating resin. It also serves as a barrier to thermal radiation.

In a second embodiment, a face sheet reinforcement is laid down as described in the above captioned patent application. A layer of foam-filled honeycomb core is laid over the reinforcement. This layer is equal to slightly less than half of the total core thickness to be encapsulated between the face sheets. A layer of non-woven polyester veil is laid over the first core sheet. The veil acts as an interface between the cores and the barrier, becoming saturated with resin during the infusion process, binding the internal cores together. The acoustical barrier is laid over the veil. The layer is roughly 0.06″ (1.5 mm) thick and comprised of non-vulcanized cork which contains as little rubber as possible. The acoustical barrier should not extend to the limits of the part to be molded; rather, the barrier covers roughly 60% of the total surface area and may be located in spots on the floor where there is likely to be more sound energy transmitted from the chassis. A fibrous mat of required thickness roughly equal to the center layer such as Rovicore™ lofted reinforcement or UPICAMat™ core is placed around the edges of the barrier sheet to fill out the gap between the edges of the sheet and the edges of the part. Another layer of veil is placed over the entire core surface, followed by a final layer of foam-filled honeycomb core, which extends to the extremities of the part. This layer is equal to slightly less than half of the total core thickness to be encapsulated between the face sheets. It is in turn overlaid with face sheet reinforcement.

### BRIEF DESCRIPTION OF THE DRAWINGS

One embodiment of the invention will now be described in conjunction with the accompanying drawings in which:

FIG. 1 is taken from a prior application and is an isometric view of the front two sections of a structural floor panel for use in a vehicle and particularly a low floor mass transit vehicle.

FIG. 1A is taken from a prior application and is cross sectional view of the panel of FIG. 1.

FIG. 2 is taken from a prior application and is a transverse cross sectional view through a mounting plate for use in manufacture of the structural shear panel of FIG. 1.

FIG. 3 is taken from a prior application and is a cross sectional view of the mounting plate of FIG. 2 with the components of the panel applied onto the mounting plate.

FIG. 4 is taken from a prior application and is a cross sectional view of the mounting plate of FIG. 3 between the panel of FIG. 6 and including a vacuum infusion system for drawing resin into the structure of the panel of FIG. 6.

FIG. 5 is a transverse cross sectional view through a further embodiment of a mounting plate for use in manufacture of the floor panel of according to the present invention.

FIG. 6 is an isometric view of a first embodiment of floor panel of according to the present invention cut along a center line.

FIG. 7 is a cross sectional view of the floor panel of FIG. 6.

FIG. 8 is an isometric view of a second embodiment of floor panel of according to the present invention cut along a center line.

FIG. 9 is a cross sectional view of the floor panel of FIG. 8.

In the drawings like characters of reference indicate corresponding parts in the different figures.

### DETAILED DESCRIPTION

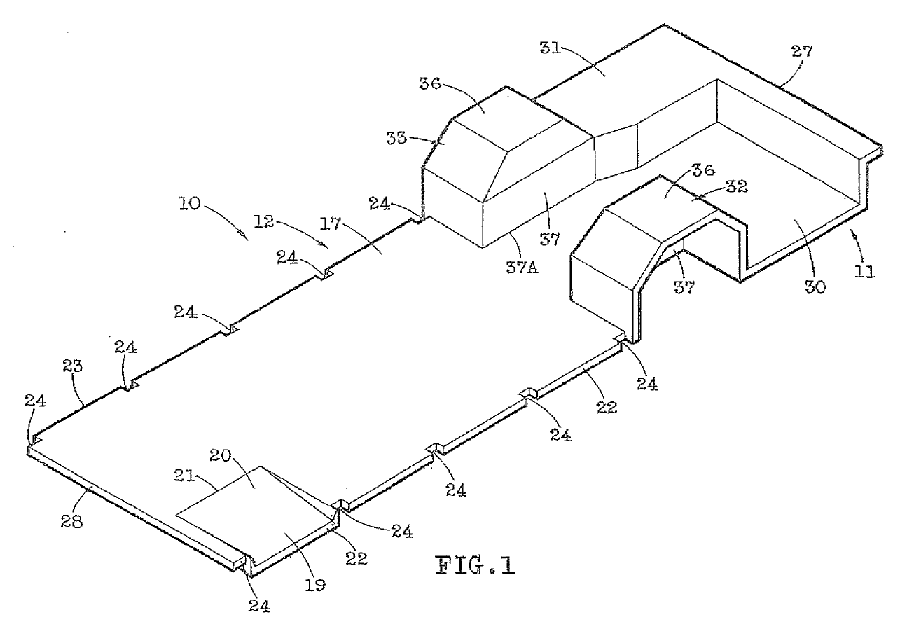

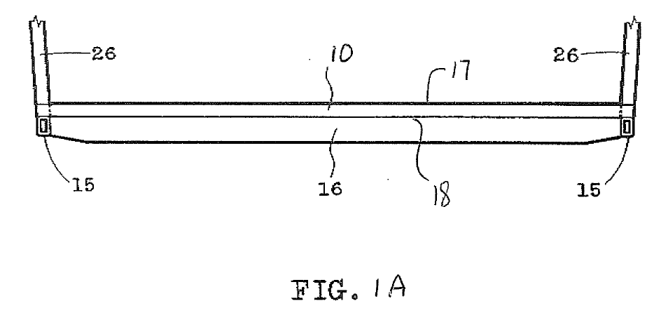

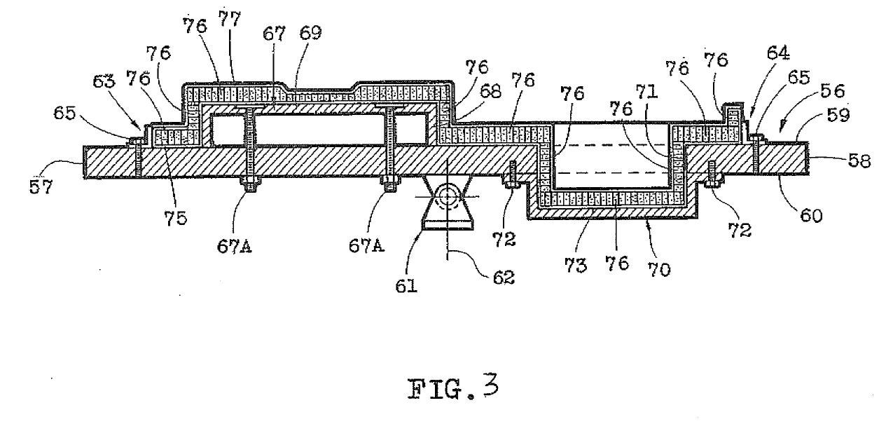

FIGS. 1 to 4 are taken from prior US Published Application 2008/0044630 filed Aug. 30, 2007 and published Feb. 2, 2008 and assigned to the present Applicants which corresponds to Canadian Application 2,599,560 and show in general a type of floor panel in which the present invention can be used.

Also the panels may be simple rectangular panels used side by side in an array as a replacement for rectangular plywood sheets to cover a floor of a vehicle.

A structural shear panel for use with a low floor mass transit vehicle is shown in FIG. 1 as generally indicated at 10.

The arrangement shown in FIG. 1 provides a shear panel for mounting over the frame of the vehicle so as to provide a floor structure. The shear panel is arranged to be mounted upon a frame structure of the vehicle which is generally of a conventional nature. Thus as shown in FIG. 1A the frame structure includes side rails 15 of the vehicle together with transverse beams 16 at spaced positions along the length of the vehicle. The panel 10 is applied over the beams 16 and is attached thereto by adhesive so that the frame formed by the side rails 15 and the cross beams 16 is structurally connected to the panel 10 so as to provide a common structural element accommodating structural loads of the vehicle.

The panel 10 is substantially a flat or planar structure having a flat upper surface 17 and a flat lower surface 18 sitting on the beams 16. In most cases the panel 10 does not require raised sections. However the panel 10 includes a rear floor ramp 19 which has a top surface 20 inclined from an edge 21 downwardly and outwardly to form an outer edge 22 at the side edge of the panel where the edge 22 is depressed or recessed relative to the upper surface 17.

The panel 10 is flat over its main body so that the upper surface 17 is planar with that surface extending to the side edges 22 and 23 and also extending between the front edge 27 and rear edge 28. The side edges have cut-out portions 24 for the posts 26 of the side walls standing upwardly from the trails 15 as shown in FIG. 1A. Thus the panel remains in a common plane with the main body at the side edges so that the bottom surface can rest directly on the planar surfaces of the frame and the top surface 17 can provide a flat floor surface on which the occupants can stand and walk.

The front section 11 includes a main body portion 30 which forms a flat floor surface which in the finished structure is coplanar with the surface 17. However in addition the front section 11 also includes raised portions 31 and wheel arches 32 and 33. In addition the front section 11 includes a recessed section 34 which is somewhat similar to the recess section 20 at the rear door with the recessed section 34 providing a similar ramp arrangement at a front door. It will be appreciated therefore that in relation to the flat main floor 30, the section 34 is recessed and the sections 31, 32 and 33 are elevated.

The wheel arches 32 and 33 each provide an arched wall 36 and an end wall 37. The arches are formed not as a smooth curved arch but as three or more panels, each integrally connected to the next, which are flat with two of the panels being inclined upwardly and inwardly and a top panel being generally horizontal. The bottom edge of the front and rear panels of the arch are integrally formed with the front section 11. The end wall of the arch 36 is connected at its lower edge 37A to the main portion 30 of the front panel 11.

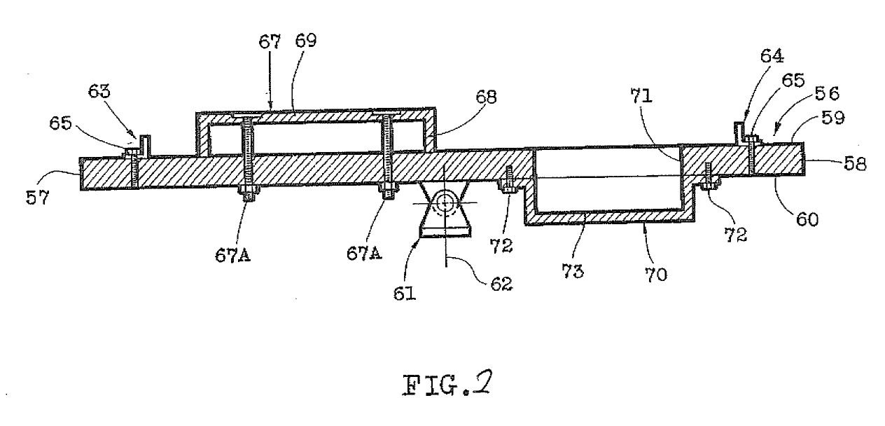

Turning now to FIGS. 2, 3 and 4 there is shown a method for manufacturing panels such as the panels 10. It will be appreciated that different designs and arrangements of vehicle require different designs and arrangements of the individual panels. The arrangement shown in FIG. 2 shows schematically an arrangement by which the panels can be manufactured using a system which can be modified to accommodate the required shape of the individual panels. Depending upon the numbers of panels of any single design to be manufactured, a single mounting plate can be used and adapted for manufacturing separate panel shapes. Alternatively separate mounting plates can be provided each for manufacturing a dedicated panel which can be re-designed as required.

Schematically as shown in FIG. 2 there is provided therefore a mounting plate generally indicated at 56 which is in the form of a large rectangular plate member having side edges 57 and 58. The plate has an upper surface 59 and a bottom surface 60. The plate is mounted on a support schematically indicated at 61 which is arranged a center line 62 of the mounting plate allowing the mounting plate to rotate around an axis along the center line so as to change the orientation of the mounting plate from the horizontal orientation as shown to approximately vertical orientation on either side of the horizontal.

This rotation of the mounting plate is used for two separate purposes in that firstly it can turn the mounting plate to face an operator so that the operator can apply the components to the mounting plate while the mounting plate is standing substantially vertically or is inclined toward the operator thus avoiding the necessity for the operator climbing onto the mounting plate. Secondly the rotation of the mounting plate from horizontal to vertical changes the direction of the force of gravity on the components carried on the mounting plate. This rotation can be used to use gravity to cause resin to run across the plate toward the elements that are temporarily at the bottom. Thus the side edge 58 can be located at the bottom causing resin toward that side edge. Rotation so that the side edge 57 is at the bottom causes resin to run toward that side edge. In this way the resin can be caused to flow to required locations during the resin infusion stage.

On the mounting plate 56 is provided a series of edge location members 63 and 64 which defines respectively side edges of the panel to be formed. Similar edge members are provided at the front and rear edges of the panel. These edge defining members are bolted or otherwise attached to the base plate 56 in a way which allows them to be moved and relocated so as to change the dimensions of the panel to be formed. In the embodiment shown the edge members are shown as simple angle members with a bottom flange lying flat on the top surface 59 and bolted thereto by fasteners 65. However other more complicated mounting arrangements can be provided which temporarily or removably attach the edge defining members to the plate but at the same time provide a seal of the edge member relative to the plate for the resin infusion process using vacuum. The selected edge defining members provide a flange which is upstanding from the plate and defines an intended thickness of the panel.

On the plate is also provided a raised form member generally indicated at 67. This form member has side walls 68 and a top wall 69. In the embodiment shown the side wall 68 stands at right angles to the top surface 59 and the top surface 69 is generally parallel to the surface 59. However it will be appreciated that these angles are not necessarily selected and raised mounting form 67 can be shaped in any required shape to provide a required recess section on the finished panel. The raised form 67 is bolted by bolts 67A to the plate. The attachment again is of a nature which allows the raised form to be moved or removed from the plate. Different raised forms of different shapes can be attached as required at different locations on the plate to provide the required shaping of the panel when finished. The attachment arrangement is selected so that it does not provide any interference with the surface of the plate and the surface of the raised form since it will be appreciated that the top floor surface of the finished panel is defined by the shaping of the exposed top surface of the plate member and thus the plate member should not include any components which interfere with or detract from the smooth and attractive nature of the surface so formed.

In addition to the raised form 67, recessed surfaces can be formed by providing a recessed form member 70 which is located at a hole 71 in the plate 56. Thus the recessed form 70 is bolted by fasteners 72 to the underside of the plate so as to provide an upper surface 73 which cooperates with the top surface 57 of the plate to form a recessed element in the panel when formed so that when the panel is inverted the recessed form 70 defines a raised element on the panel.

Thus it will be appreciated that in one example, the step 50 can be formed on the panel 13 using the raised form 67 and the wheel arches 52 and 53 can be formed on the panel by using the recessed form 70. Other raised and recessed components of the panel as required by a particular design can be manufacturing using selected different shapes and arrangements of the raised forms and the recessed forms together with suitable shaping of the holes 71 in the plate.

In FIGS. 2, 3 and 4 is shown a complex panel with complex formed shape for forming a whole floor panel arrangement. In FIG. 5 is shown a simple rectangular panel of constant thickness, with the intention that the panels of FIG. 5 are used side by side in an array over a supporting frame.

With the plate 56 thus formed to the required shape, simple or complex, to form a particular panel, the panel is formed on the plate. The panel is formed by providing a first sheet 75 of a fiber reinforced material which is formed with fiber reinforcement in both longitudinal and transverse directions. The sheet 75 is laid over the surface 59 and over the surfaces of the raised and recessed forms (if present) up to the edge defining member 63 and 64 where the sheet is folded so that it projects upwardly along the inside surface of that member. Thus the sheet 75 closely follows the surface of the mold to provide the required shape of what will become the top surface of the panel when formed.

With the sheet 75 in place, a series of core members is provided as indicated at 76 which are laid over the surfaces in the required positions. These core members are panels of core material which are cut to the required shape and laid in place over the surfaces. The thickness of the panels is selected to provide a required thickness of the panel when formed. Thus, in the complex panel, in some cases the panels at certain areas are thinner than others of the structure. In particular the vertical surfaces may be thinner than the horizontal surfaces. In most cases and particularly in the simple panels, the thickness is constant over the area of the applied panel piece. In other cases the panel pieces may be machined so that their thickness is reduced at certain locations. In this way the panel pieces are assembled to form a core structure which extends through the whole area of the panel to be formed and follows the shape of the surface to be formed defined by the surface 59 and the surfaces of the raised and recessed forms.

With the panel pieces in place, a top sheet 77 is applied over the whole structure. The top and bottom sheets are preferably formed as a single sheet of material but if the size is such that a single sheet is impractical, separate individual sheets can be laid and overlapped and connected to provide the structural strength equivalent of the single sheet.

With the sheets in place containing the core material therebetween, resin is infused through the complete structure. This infusion is effected using conventional techniques known to persons skilled in this art.

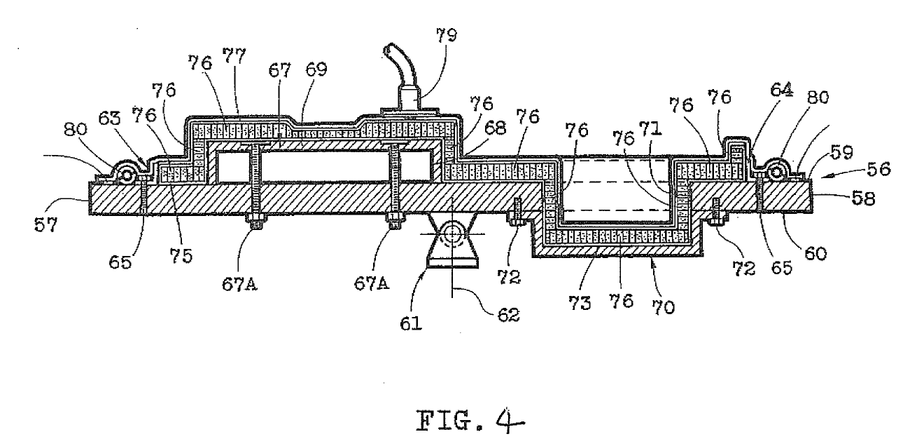

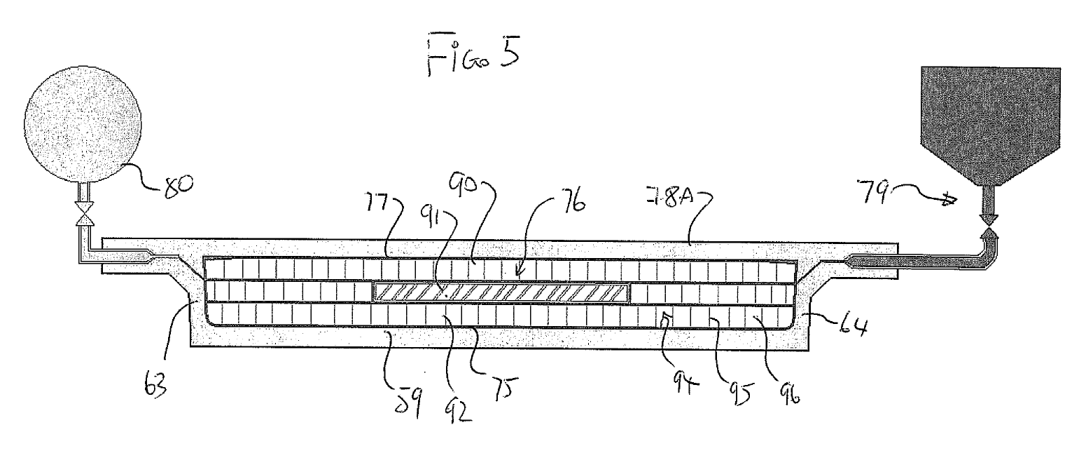

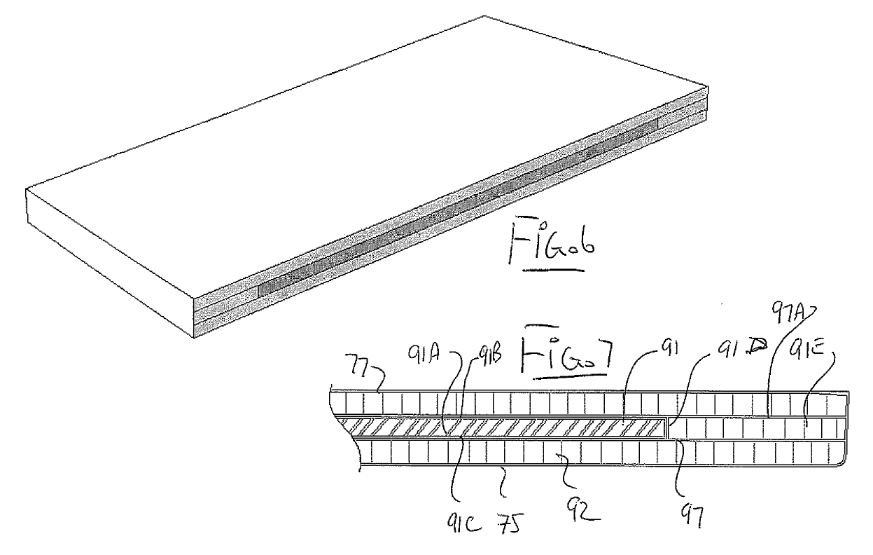

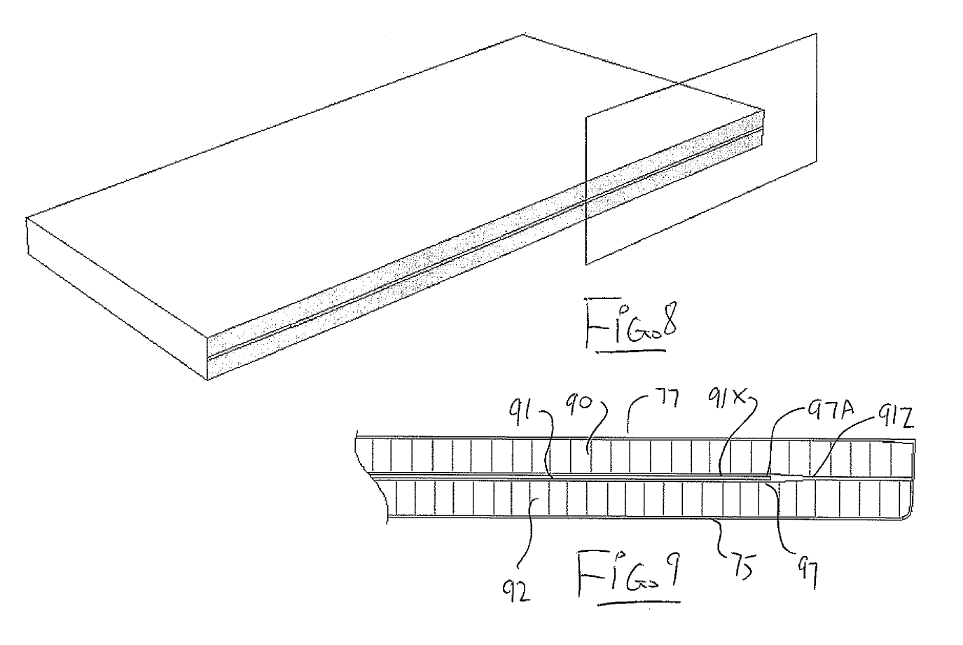

Thus the system includes a resin infusion container in the form of a top plate 78A (FIG. 5) or bag 78 (FIG. 4) which engages over the whole structure so that the vacuum can be applied at various locations across the container.

Resin is injected at certain locations within the structure as indicated at 79. The vacuum is drawn at a vacuum extraction point 80. During extraction, the orientation of the materials on the support plate can be changed to utilize gravity to assist the resin to flow through the panel from the injection ports 79 to the extraction ports 80 to ensure that the resin is properly infused through the whole structure to integrate the structure as required to provide the necessary structural strength.

The core material 76 is formed of a plurality of parallel layers parallel to the first and second sheets 75 and 77. In the embodiments shown there are three layers 90, 91 and 92. The first layer 90 and the second layer 92 are each formed from a honeycomb panel defining an array of hexagonal tubular cells 94 with walls which extend in the thickness direction where at least some of the cells are at least partly filled with a foam material.

The first and second layers are each formed from a honeycomb panel defining an array of hexagonal tubular cells with walls which extend in the thickness direction where at least some of the cells are at least partly filled with a foam material 96. The honeycomb panel is typically formed from phenolic resin infused Kraft paper but other suitable materials can be used which are selected to bond to the filling polyurethane foam and to provide a suitable compression strength.

The third layer 91 is located between the first and second layers and is formed of a material which is free from tubular cells in the thickness direction and free from rigid structural members in the thickness direction. Thus the third layer contains no honeycomb stiffening members and the third layer has no hollow tubes or openings extending through the layer into the top and bottom layers so that when resin infused no stiff resin cores are formed which are continuous from top sheet to bottom sheet.

In the first embodiment shown in FIGS. 5, 6 and 7, the face sheet reinforcement 75 is laid down and a first layer 92 of the foam-filled honeycomb core is laid over the reinforcement sheet. The layer 92 is approximately equal to one third of the total core thickness to be encapsulated between the face sheets 75 and 77. This proportion of the total thickness may vary particularly where the total thickness varies as in the complex panel constructions.

A layer of non-woven polyester veil 97 is laid over the first core sheet 92. The veil 97 is a conventionally available material commonly used in fiber reinforcement structures and acts as an interface between the layers 92 and 91 when it becomes saturated with resin in the infusion process, binding the internal layers together. The second layer 91 which forms an acoustical barrier is laid over the veil 97.

The layer 91 is again approximately equal to one third of the total core thickness to be encapsulated between the face sheets 75 and 77. The acoustical barrier is comprised of high-density, closed cell foam 91A encapsulated between two thin face sheets of aluminum foil 91B and 91C. The acoustical barrier does not extend to the limits of the panel and terminates at edges 91D which are spaced from the edges of the panel. The barrier commonly covers roughly 60% of the total surface area. While it is shown as a single piece spaced from the edges of the panel, the barrier layer 91A may be located in spots or areas on the floor where there is likely to be more sound energy transmitted from the chassis. Thus the design is selected and arranged to maintain sufficient strength in the panel by limiting the total area of the layer 91A while locating the layer in the best positions to maximize sound attenuation.

Standard honeycomb core the same as the layers 90 and 92 is placed around the edges of the barrier core as indicated at 91E to fill out the core to the edges of the part to maintain the constant thickness over the panel. Another layer 97A of veil is placed over the entire core surface, followed by the final layer 90 of the foam-filled honeycomb core, which extends to the edges of the panel. This layer 90 is again approximately equal to one third of the total core thickness to be encapsulated between the face sheets. It is covered with face sheet 77.

The sandwich is then resin infused. In previous resin infusion processes, the foam-filled honeycomb core sheet is passed through a saw set up to cut narrow, shallow channels into the top and bottom surfaces. These are generally on a 4″ grid and extend ideally no more than 0.025″ into the surface. The channels describe squares of core surface. In the middle of each square, a hole is drilled through the core. The core is placed in the mold and a vacuum bag is placed over the matrix of core and reinforcement. The space under the blanket is evacuated and then a valve is opened on the resin pot; catalyzed resin is forced through a “gate” in the bag onto the top surface of the matrix by atmospheric pressure. The resin quickly spreads to the channels scribed into the surface of the core under the reinforcement and runs along these channels. As it spreads over the core surface, resin finds the tunnels and is conducted by pressure to the mold side of the matrix, where it collects in those resin channels and is thereby distributed across the top and bottom faces of the laminate towards the vacuum ports. The tunnels cannot be located at the conjunction of the channels, the resin would spread too quickly to the mold side, starving the bag side of the part. When the resin catalyzes, the tunnels become these brittle little columns of pure resin. The tunnels become vectors for transmission of sound energy. This process, tunnels and scoring, is well known in the prior art.

The above is not an ideal means of infusion for cosmetic parts—the channels and the tunnels contain a lot of neat resin (cost+weight) and un-reinforced resin has a tendency to shrink more than the glass reinforced resin. This causes sink marks in the surface, which can be tolerated in a floor with a linoleum or rubber covering, but an entirely unacceptable state of finish for a decorative finish (Class “A”), usually gel coat of one kind or another. The sink marks telegraph or witness on the glossy surface of the part.

The process used in the present method is free of tunnels, relying instead on an “edge gating” technique, in which the reinforcement doubles as a wicking membrane, conducting the resin from the edge gate at the edge of the panel through the matrix and across the top and bottom, without the benefit of channels in the top and bottom surfaces or tunnels through the panel.

The resulting sandwich is acoustically “dead”, transmitting very little acoustic energy. The foil is a component of the molding process in that it protects the acoustic foam core from the momentarily corrosive effects of the styrene monomer contained in the laminating resin. It also serves as a barrier to thermal radiation.

In the second embodiment, the construction is very similar with three layers as previously described. In this embodiment, the layers 90 and 92 of foam-filled honeycomb core are equal to slightly less than half of the total core thickness to be encapsulated between the face sheets 75 and 77. The layers 97, 97A of non-woven polyester veil are provided as described above. The acoustical barrier 91X is laid over the veil. The layer is roughly 0.06″ (1.5 mm) thick and comprised of non-vulcanized cork which contains as little rubber as possible. The acoustical barrier 91X does not extend to the limits of the panel. A fibrous mat 91Z of required thickness roughly equal to the center layer such as Rovicore™ lofted reinforcement or UPICAMat™ core is placed around the edges of the barrier sheet to fill out the gap between the edges of the sheet and the edges of the part. Another layer of veil is placed over the entire core surface.

The third or center layers 91 are formed of a homogeneous material which is resilient in the thickness direction so that there are no rigid member extending in the thickness direction through this layer and it acts as a break in the rigid structure of the layers 90 and 92.

The above described construction provides the sound attenuation required while providing at least four primary benefits:

Light weight, where a ¾″ thick sandwich floor weighs just 1.50 lbs/sq. ft.

Superior performance to plywood in that the product of the present arrangement will never absorb water, rot, delaminate, split, swell, soften, or crack, over the life of the vehicle. There are no organic materials, such as balsa wood, to rot in the structure.

Consolidation of parts in that the configurable tooling facilitates the consolidation of parts, such as the rear step, or wheel housings, into the flooring matrix, eliminating separate parts, joints, fluid and gas leaks, and the assembly costs associated with multiple part assemblies. Moreover, a unitized flooring package of the present arrangement adds to the structural integrity of the chassis. The vestibule, dashboard, and operator's platform can be combined into one, drop-in unit that has its own structural integrity, and is self-insulating.

Easy installation, unlike plywood and all other composite floors, the floors of the present arrangement are supplied to the vehicle production line molded in one piece, with factory-sealed edges, ready to install. No joints to fill, no jig saw puzzle of boards to assemble and screw down to the structure. Each deck is self supporting during installation and can be lifted out of its steel shipping container and onto the chassis using suction cups, without fear of cracking, bending, or delaminating. Typical labor savings for floor assembly are in the range of 42 man hours.

The panel of the present arrangement can be supplied complete with the floor covering factory installed so that there is no more cutting and gluing and no more harmful VOCs.

The variable geometry molds can be configured to match almost any floor design. In most cases, the upper and main decks as well as the entrance area (commonly referred to as the vestibule) can be vacuum molded in a master form in one sequence, amortizing set-up costs and maximizing efficiency. The edges are factory sealed as part of the molding process. The panel can provide floors with sloped areas at the entrance and exit doors.

While there are many benefits using the composite flooring of the present arrangement as a straight replacement for plywood flooring, its often overlooked attributes as a structural component could prove even more beneficial, especially where weight and cost savings are important. Specifically, in thicknesses over 1.0″, the composite sandwich floor interacts synergistically with the chassis when bonded directly to it, increasing the stiffness of the entire assembly. Thus, using the structural floor assembly, the spans or spaces between the transverse bulkheads can be substantially increased and the number of bulkheads thus reduced. The longitudinal stringers are strictly for alignment and stabilization of the bulkheads and absorption of the thrust loads placed on the chassis by the movement of the vehicle. The estimated weight for a 133 sq. ft main deck, including the mild steel transverse bulkheads and longitudinal stringers shown in the drawing would be 617 lbs. This can be significantly reduced.

Unlike other composite flooring comprised of individual panels bonded together, the structural sandwich floor of the present arrangement is a unified structure. The top and bottom skins encapsulating the core are of a single piece, that is, the reinforcing glass matrix extends the entire length and width of the floor without interruption. This means that the bending stresses placed on the sandwich are distributed over the entire floor, rather than between the supporting structural members.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A floor panel for a vehicle, the panel comprising:
a first sheet, a second sheet and a core material between the sheets where the core material fills a space between the sheets in a thickness direction;
each of the first and second sheets being formed of a fiber reinforced material so as to provide strength against tension in both a longitudinal direction and a transverse direction;
the core material having a thickness in the thickness direction so as to hold the first and second sheets spaced by a distance to provide a resistance of the panel to bending;
and a resin permeated through the sheets and into the core material;
the core material comprising a plurality of parallel layers parallel to the first and second sheets;
the parallel layers including a first layer and a second layer;
where the first and second layers are each formed from a honeycomb panel defining an array of hexagonal tubular cells with walls which extend in the thickness direction where at least some of the cells are at least partly filled with a foam material;
the parallel layers including a third layer located between the first and second layers;
the third layer being formed of a material which is free from tubular cells in the thickness direction and free from rigid structural members in the thickness direction.

2. The panel according to claim 1 wherein there are only three layers.

3. The panel according to claim 1 wherein the first and second layers are arranged symmetrically and of equal thickness and third layer is a dividing layer located at a center of the panel.

4. The panel according to claim 1 wherein the third layer is of a homogeneous material.

5. The panel according to claim 1 wherein the third layer is resilient in the thickness direction.

6. The panel according to claim 1 wherein the third layer is of a foam material.

7. The panel according to claim 1 wherein the third layer is of a resilient material.

8. The panel according to claim 6 wherein the third layer is of substantially equal thickness to the first and second layers.

9. The panel according to claim 7 wherein the third layer is thinner than the first and second layers.

10. The panel according to claim 1 wherein the third layer is smaller than the first and second layers in the transverse and longitudinal directions so that the third layer is spaced from the edges of the panel.

11. The panel according to claim 10 wherein there is provided spacer pieces at locations on the panel outside the third layer with the spacer pieces having a thickness substantially equal to the third layer.

12. The panel according to claim 1 wherein the third layer is located at positions on the panel where noise is high and there are provided spacer pieces at locations on the panel remote from the third layer with the spacer pieces having a thickness substantially equal to the third layer

13. The panel according to claim 11 wherein the spacer pieces are formed from a honeycomb panel with an array of hexagonal tubular cells defining walls which extend in the thickness direction where at least some of the cells are at least partly filled with a foam material.

14. The panel according to claim 11 wherein the spacer pieces are formed from a fibrous mat.

15. The panel according to claim 1 wherein the third layer is formed from a layer of a foam material with faces thereof parallel to the sheets being covered by a foil.

16. The panel according to claim 15 wherein the third layer is a high density closed cell foam.

17. The panel according to claim 1 wherein there is provided a fibrous binding layer between the first layer and the third layer and between the second layer and the third layer with the fibrous binding layer being permeated with the resin.

18. The panel according to claim 17 wherein the fibrous binding layer is a polyester veil.

19. The panel according to claim 1 wherein the third layer has no resin tunnels extending in the thickness direction.

20. The panel according to claim 1 wherein the panel has side edges which are covered by edge portions of the first and second sheet.

21. The panel according to claim 1 wherein the panel is of a constant thickness.

22. The panel according to claim 1 wherein the panel has thicker portions.

23. A vehicle comprising
a frame including a plurality of frame members for supporting a floor;
a floor panel placed over the frame so as to be supported by the frame members;
floor panel being substantially as claimed in claim 1.

24. The vehicle according to claim 23 wherein the vehicle has side walls at side edges of the frame with the frame members extending across the vehicle between the walls and wherein the floor panel extends between the side walls.

25. The panel according to claim 23 wherein the vehicle has side walls at side edges of the frame with the frame members extending across the vehicle between the walls and wherein there is provided a plurality of separate floor panel arranged side by side between the side walls.
